(19) United States
(12) Patent Application Publication
(10) Pub. No.: US 2019/0082872 A1
(43) Pub. Date: Mar. 21, 2019

(54) MULTIFUNCTIONAL BEVERAGE DEVICE

(71) Applicant: Steven Wortham, Amarillo, TX (US)

(72) Inventor: Steven Wortham, Amarillo, TX (US)

(21) Appl. No.: 15/705,822

(22) Filed: Sep. 15, 2017

(51) Int. Cl. A47G 23/02; B67B 7/16; B65D 81/38

(52) U.S. Cl. CPC A47G 23/0241; A47G 2023/0275; B65D 81/3881; B67B 7/16

(57) ABSTRACT

A multifunctional base device for opening a bottle cap from a bottle and a multifunctional beverage device including the base device are described. A bottle opener and a high-powered magnet are fixed to an upper surface of the base device such that a removed bottle cap is magnetically secured to the base device. Additionally, the high-powered magnet magnetically secures the beverage device to a metallic surface for convenient placement.

### BACKGROUND

### 1. Technical Field

The present disclosure relates generally to multifunctional devices for beverage containers. More particularly, the present disclosure relates to multifunctional devices for holding and securing beverage containers and for opening and securing bottle caps.

### 2. Description of Related Art

Insulated devices for holding beverage containers are known and typically accept beverage cans and bottles. These insulated devices are especially popular during outdoor use in order to keep beverages at a cold temperature. However, there are often limited surfaces in outdoor settings to set down beverages, so beverages must be held or, if set down on a small or crowded surface, are prone to being tipped over and spilled.

Although most beverage cans can be opened by hand without the use of any tools, many beverage bottles require the use of a bottle opener in order to remove a bottle cap prior to consumption. There are many instances where it may be inconvenient to find an available bottle opener, such as if there are many people sharing a single bottle opener or if a bottle opener cannot be found. Even if a bottle opener can be found and is used to open a bottle, the bottle cap may inconveniently need to be retrieved after removal from the bottle.

Current attempts have been made to incorporate bottle openers with beverage holders. For example, U.S. Pat. No. 7,343,834 B2 to Howlett et al. discusses a combination beverage holder and container opener. However, the design is deficient because a bottle cap removed using the container opener of the design must be chased after and retrieved. Additionally, a bottle held by the beverage holder of the design is susceptible to being tipped over and spilled.

Based on the foregoing, there is a need in the art for a multifunctional device that incorporates a bottle opener as well as a magnet to secure a bottle cap after removal and to secure the device, and thus a beverage container, to a surface.

The above problems in the related art are considered as matters that have been addressed by the inventor to derive the present inventive concept, or as matters discovered during the course of deriving the present inventive concept. Thus, the problems may not be simply referred to as information that was known to the general public prior to filing the present disclosure.

### SUMMARY OF EMBODIMENTS

Various embodiments of the present disclosure include a multifunctional base device for opening a bottle cap from a bottle. The base device may include: a base body comprising a bottom portion through which an opening is formed; an opener body that is fixed to an upper surface of the bottom portion around the opening; and a magnet that is fixed to the upper surface of the bottom portion such that at least a portion of the magnet is positioned at a center point of the bottom portion, wherein no part of the opening is positioned over the center point of the bottom portion, wherein the opener body is configured to engage and remove the bottle cap from the bottle, and wherein the magnet is configured to magnetically secure the removed bottle cap to the base device.

In an exemplary embodiment, the opening and the opener body each form an oval shape.

In another exemplary embodiment, the magnet has at least a 10-lb pull force.

In another exemplary embodiment, the base device further includes a shock absorber.

In another exemplary embodiment, the base body further includes a peripheral wall extending from an outer edge of the bottom portion.

In another exemplary embodiment, the peripheral wall includes threads.

Various embodiments of the present disclosure include a multifunctional beverage device. The multifunctional beverage device includes: a base device for opening a bottle cap from a bottle, the base device including: a base body including a bottom portion through which an opening is formed, and a peripheral wall extending from an outer edge of the bottom portion; an opener body that is fixed to an upper surface of the bottom portion around the opening; and a magnet that is fixed to the upper surface of the bottom portion such that at least a portion of the magnet is positioned over a center point of the bottom surface, wherein no part of the opening is positioned at the center point of the bottom portion, wherein the opener body is configured to engage and remove the bottle cap from the bottle, and wherein the magnet is configured to magnetically secure the removed bottle cap to the base device; and a beverage container holding body configured to receive a beverage container and that is attached to the peripheral wall of the base device.

In an exemplary embodiment, the opening and the opener body each form an oval shape.

In another exemplary embodiment, the magnet has at least a 10-lb pull force.

In another exemplary embodiment, the base device further includes a shock absorber.

In another exemplary embodiment, the beverage container holding body is attached to the peripheral wall of the base device through pressing or welding.

In another exemplary embodiment, the peripheral wall includes first threads; the beverage container body includes second threads; and the beverage container holding body is attached to the peripheral wall of the base device through engagement of the first threads and the second threads.

Various embodiments of the present disclosure include a method of using a multifunctional beverage device including: a base device for opening a bottle cap from a bottle, the base device including: a base body including a bottom portion through which an opening is formed, and a peripheral wall extending from an outer edge of the bottom portion; an opener body that is fixed to an upper surface of the bottom portion around the opening; and a magnet that is fixed to the upper surface of the bottom portion such that at least a portion of the magnet is positioned over a center point of the bottom surface, wherein no part of the opening is positioned at the center point of the bottom portion, wherein the opener body is configured to engage and remove the bottle cap from the bottle, and wherein the magnet is configured to magnetically secure the removed bottle cap to the base device; and a beverage container holding body configured to receive a beverage container and that is attached to the peripheral wall of the base device. The method includes: inserting the bottle cap in the opening such that an edge of the bottle cap rests on the opener body; exerting a force on at least one of the multifunctional beverage device and the bottle such that the bottle cap is removed from the bottle; and detaching the removed bottle cap from the multifunctional beverage device.

In an exemplary embodiment, the method further includes inserting the bottle in the beverage container holding body.

In another exemplary embodiment, the method further includes placing the multifunctional beverage device on a metallic surface such that the multifunctional beverage device is magnetically secured to the metallic surface.

In another exemplary embodiment, the metallic surface is inclined.

The foregoing, and other features and advantages, will be apparent from the following, more particular description of the exemplary and preferred embodiments, the accompanying drawings, and the claims.

### BRIEF DESCRIPTION OF THE DRAWINGS

The present disclosure will become more fully understood from the specification and the accompanying drawings, wherein:

FIG. 1 is an exploded perspective view of a multifunctional base device according to various embodiments.

FIG. 2 is a plan view of a multifunctional base device according to an exemplary embodiment.

FIG. 3 is a plan view of a multifunctional base device according to another exemplary embodiment.

FIG. 4 is an exploded perspective view of a multifunctional beverage device according to various embodiments.

FIG. 5 is a perspective view of a multifunctional beverage device according to various embodiments.

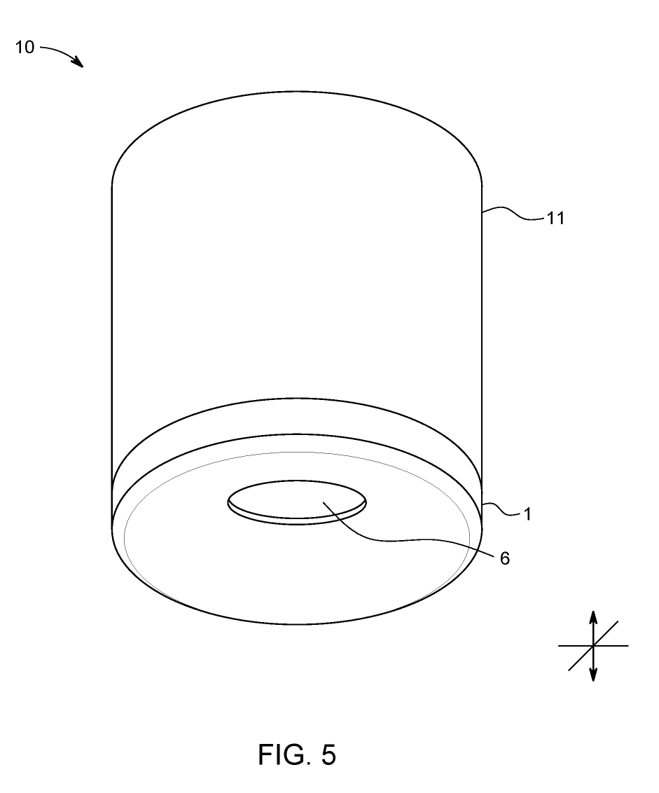

FIG. 6 is a flowchart of a method of using a multifunctional beverage device according to various embodiments.

FIG. 7 is an illustration of a multifunctional beverage device according to various embodiments.

### DETAILED DESCRIPTION OF EMBODIMENTS

The following description is merely exemplary in nature and is in no way intended to limit the various embodiments, their application, or uses. It should be understood that the terminology used herein is used for the purpose of describing particular embodiments only, and is not intended to limit the scope of the present disclosure. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may. Features that are described in the context of separate embodiments may also be provided in combination in a single embodiment. Conversely, various features that are, for brevity, described in the context of a single embodiment, may also be provided separately or in any suitable subcombination. New claims may be formulated to such features and/or combinations of such features during the prosecution of the present application or of any further application derived therefrom.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the various embodiments of the present disclosure. Structures described herein are to be understood also to refer to functional equivalents of such structures.

It should be understood that steps within a method may be executed in different order without altering the principles of the present disclosure. Additionally, the components and/or elements recited in any apparatus or system claim may be assembled or otherwise operationally configured in a variety of permutations and are accordingly not limited to the specific configuration recited in the claims.

As will be understood by one skilled in the art, all ranges recited herein also encompass any and all possible sub-ranges and combinations of sub-ranges thereof, as well as the individual values making up the range, particularly integer values. Any listed range can be easily recognized as sufficiently describing and enabling the same range being broken down into at least equal halves, thirds, quarters, fifths, or tenths. A recited range (e.g., weight percent, absolute weight) includes each specific value, integer, decimal, or identity within the range. As will also be understood by one skilled in the art, all language such as “up to,” “at least,” greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specified values recited for radicals, substituents, and ranges, are for illustration only; they do not exclude other defined values or other values within defined ranges for radicals and substituents.

The drawings described herein are for illustrative purposes only of selected embodiments and not all possible implementations, and are not intended to limit the scope of any of the various embodiments disclosed herein or any equivalents thereof. It is understood that the drawings are not drawn to scale. For purposes of clarity, the same reference numbers will be used in the drawings to identify similar elements.

Exemplary embodiments will now be described in detail with reference to the accompanying drawings.

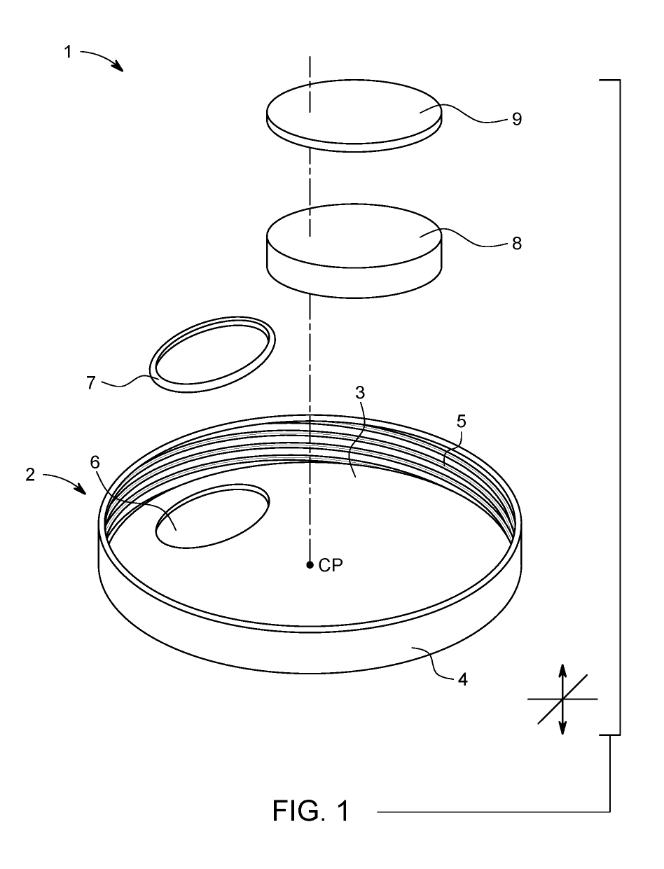

FIG. 1 is an exploded perspective view of a multifunctional base device 1 according to various embodiments.

Referring to FIG. 1, a multifunctional base device 1 comprises a base body 2 having a bottom portion 3 and a peripheral wall 4 that extends from the outer edge of the bottom portion 3. In some embodiments, the base body 2 may preferably be constructed of stainless steel, although other suitable materials may be used. For example, a flat sheet of stainless steel may be pressed to shape using a mold and hydraulic press to form the base body 2. In a preferred embodiment, the bottom portion 3 and the peripheral wall 4 each have a thickness of 0.7 millimeters (mm), and the peripheral wall 4 has a height of 20 mm. In an exemplary embodiment, threads 5 may be formed on the surface of the peripheral wall 4.

An opening 6 is formed through the bottom portion 3 such that the opening 6 is positioned off-center of the bottom portion 3. In other words, the opening 5 is formed through the bottom portion 3 such that no part of the opening 6 is positioned at a center point CP of the bottom portion 3. The opening 6 is of a suitable size and shape to allow a conventional bottle cap to be removed from a conventional beverage bottle. In a preferred embodiment, the opening 6 forms an oval shape. However, the opening 6 may form other shapes.

The multifunctional base device 1 further comprises an opener body 7 that is fixed to an upper surface of the bottom portion 3 around the opening 6. In a preferred embodiment, the opener body 7 is made of stainless steel and is welded to the upper surface of the bottom portion 3 around the opening 6. In a preferred embodiment, the opener body 7 has a thickness of 1.5 mm. The opener body 7 engages and removes a bottle cap while preventing the bottom portion 3 from being warped or damaged.

The opener body 7 includes an opening through which the bottle cap is inserted for removal. The opening of the opener body 7 preferably matches the size and shape of the opening 6 of the bottom portion 2. Alternatively, the opening of the opener body 7 may be slightly smaller in size, but generally has the same shape as the opening 6 of the bottom portion 2. In a preferred embodiment, the opening 3 of the bottom portion 2 and the opening of the opener body 7 both form an oval shape. The oval shape advantageously allows a bottle cap to be removed from multiple angles using the base device 1.

The multifunctional base device 1 further comprises a magnet 8 that magnetically secures a removed bottle cap to the base device 1. If the base device 1 is attached to a beverage holding container, the magnet 7 may also secure the base device 1 and the beverage holding container to a metal surface to prevent a beverage from spilling. In some embodiments, the magnet 8 is a high-powered neodymium magnet with a sufficient pull force to secure the base device 1 (and any beverage container holding body and beverage container attached thereto) to a metal surface, even if the metal surface is significantly inclined. For example, the metal surface may be inclined if sloped at an angle greater than 0 degrees, and may be significantly inclined if sloped at an angle greater than 10 degrees. In another example, the surface may be a vertical surface (90°), such as the side or door of a refrigerator, vehicle, or toolbox, or may even be an inverted surface (180°), such as the bottom of a work shelf or the like. In some embodiments, the magnet 8 may have a 10-pound (lb) to 35-lb pull force as suitable. In other embodiments, the magnet 8 may have at least a 35-lb pull force. Accordingly, the base device 1 (and beverage container holding body and beverage container attached thereto) may be secured to a metal surface at any angle.

The magnet 8 is fixed to the upper surface of the bottom portion 3 such that the magnet 8 is more centrally located on the bottom portion 3. In some embodiments, the magnet 8 is fixed to the upper surface of the bottom portion 3 such that at least a portion of the magnet 8 is positioned over a center point of the bottom portion 3. The centralized positioning of magnet 8 relative to bottom portion 3 increases the stability of the base device 1 when secured to a metal surface. The magnet 8 may be fixed to the upper surface of the bottom portion 3 through adhesive or other suitable means.

In some embodiments, the multifunctional base device 1 may further comprise a shock absorber 9. The shock absorber 9 is fixed to an upper surface of the magnet 8, such as through adhesive or other suitable means, and may be constructed of rubber.

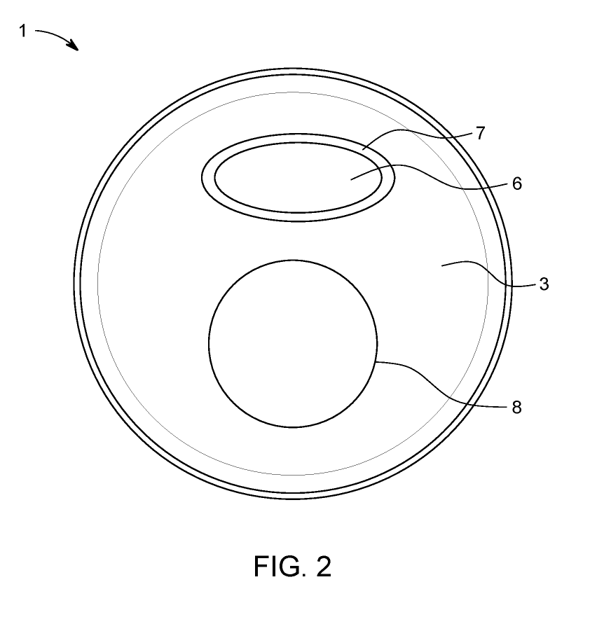

FIG. 2 is a plan view of the multifunctional base device 1 according to an exemplary embodiment where opening 3 and opener body 7 are oval-shaped.

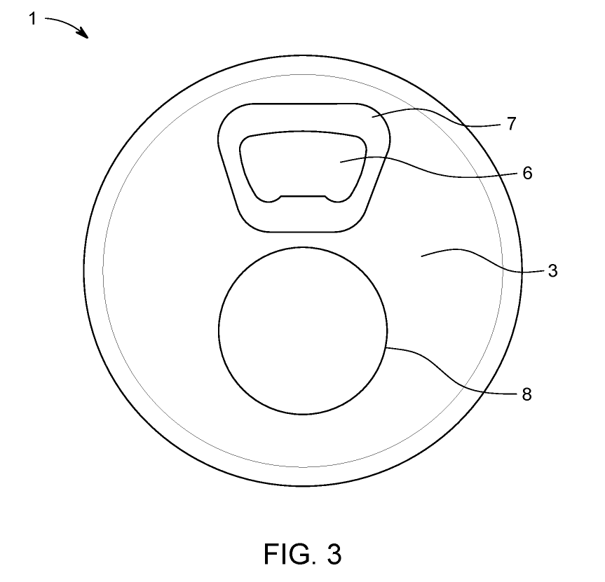

FIG. 3 is a plan view of the multifunctional base device 1 according to an exemplary embodiment where opening 3 and opener body 7 form another exemplary shape.

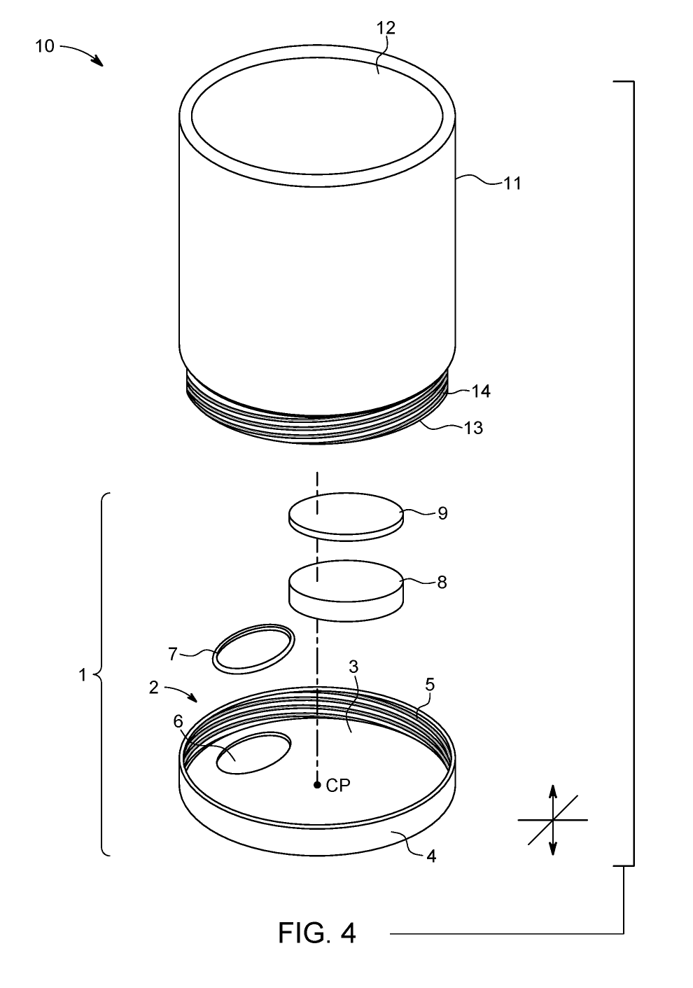

FIG. 4 is an exploded perspective view of a multifunctional beverage device 10 according to various embodiments. In FIG. 4, the same reference numerals as those of FIG. 1 denote the same elements. Thus, the differences of the exemplary embodiment(s) illustrated with reference to FIG. 4 from the exemplary embodiment(s) illustrated with reference to FIG. 1 will be described below.

Referring to FIG. 4, the multifunctional beverage device 10 comprises the base device 1 as discussed above and a beverage container holding body 11. In some embodiments, the beverage container holding body 11 generally forms a cylindrical shape with an open upper end 12 and a closed lower end 13. As such, the beverage container holding body 11 is configured to receive a beverage container, such as a can or bottle, or the contents of the beverage container at the upper end 12 thereof. For example, the beverage container holding body 11 may be a cup, koozie, jug, bottle, or other suitable drinking apparatus of various sizes. In some embodiments, the beverage container holding body 11 may be made of stainless steel and may have a double-wall vacuum insulated construction.

The beverage container holding body 11 is attached to the peripheral wall 4 of the base device 1 at the lower end thereof. In an exemplary embodiment, the base device 1 is hydraulically pressed onto the beverage container holding body 11, such as if base device 1 and beverage container holding body 11 do not include threads 5 and threads 14, respectively. Additionally or alternatively, the seam between the pressed base device 1 and beverage container holding body 11 may be welded. In another exemplary embodiment, threads 14 are formed on the lower end 13 of the beverage container holding body 11, and the beverage container holding body 11 is attached to the peripheral wall 4 of the base device 1 by engaging the threads 12 of the beverage container holding body 11 with the threads 5 of the base device 1.

In an exemplary embodiment, shock absorber 9 is attached to a lower surface of the lower end 13 of the beverage container holding body 11, such as through adhesive or other suitable means.

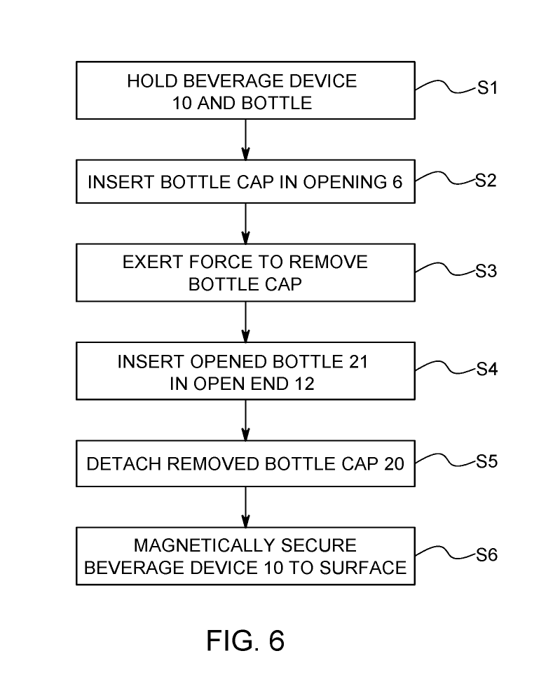

FIG. 6 is a perspective view of the multifunctional beverage device 10 according to various embodiments.

Referring to FIG. 6, the beverage container holding body 11 is attached to the base device 1 such that opener body 7, magnet 8, and shock absorber 9 are substantially hidden from view. Such an arrangement creates a more attractive appearance compared to other designs where functional elements are exposed.

FIG. 6 is a flowchart of a method of using the multifunctional beverage device 10 according to various embodiments.

Referring to FIG. 6, the method begins when a person holds the multifunctional beverage device 10 with one hand and holds a capped beverage bottle (not shown) with the opposite hand (step S1). The person then inserts the bottle cap in the opening 6 such that an edge of the bottle cap rests on the opener body 7 (step S2). Next, the person exerts a force on at least one of the beverage device 10 and the capped beverage bottle such that the bottle cap is removed from the beverage bottle using the opener bottle 7 and remains magnetically secured to the beverage device 10 due to the magnet 8 (step S3). The person then inserts the opened beverage bottle into the open end 12 of the beverage container holding body 11 (step S4). Next, the person detaches the removed bottle cap from the beverage device 10 for disposal (step S5). Finally, the person places the beverage device 10 on a metallic surface such that the beverage device 10 is magnetically secured to the metallic surface due to the magnet 8 (step S6). For example, the beverage device 10 may be placed on an inclined or significantly inclined metal surface, but movement of the beverage device 10 is prevented due to the magnet 8.

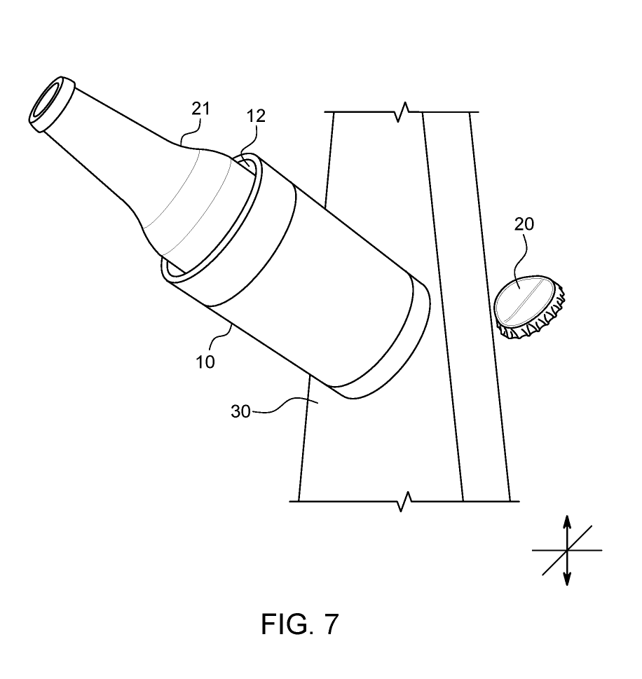

FIG. 7 is an illustration of the multifunctional beverage device 10 according to various embodiments, for example, as a result of performing the method described with reference to FIG. 6.

Referring to FIG. 7, a bottle cap 20 has been removed from a beverage bottle 21 and detached from the multifunctional beverage device 10 for disposal, and the beverage bottle is inserted in the open end 12 of the beverage device 10. The beverage device 10 is magnetically secured to an inclined metallic surface 30 such that movement of the beverage device 10 is prevented.

Various embodiments have been described with reference to the accompanying drawings. As is apparent from the foregoing description, the various embodiments address the need in the art for a multifunctional device that incorporates a bottle opener as well as a magnet to secure a bottle cap after removal and to secure the device, and thus a beverage container, to a surface. Particularly, the opener body 7 allows for convenient removal of a bottle cap, while high-powered magnet 8 magnetically secures the removed bottle cap. Thus, a bottle cap does not need to be chased down and retrieved after removal. The high-powered magnet 8 also secures the multifunctional beverage device 10 to metallic surfaces for convenient placement when surface area is limited.

Additionally, although the disclosed subject matter has been described in conjunction with specific embodiments, numerous modifications and alterations are well within the scope of the present disclosure. Accordingly, the specification and drawings are to be regarded in an illustrative rather than a restrictive sense.

1. A multifunctional base device for opening a bottle cap from a bottle, the base device comprising:
a base body comprising a bottom portion through which an opening is formed;
an opener body that is fixed to an upper surface of the bottom portion around the opening; and
a magnet that is fixed to the upper surface of the bottom portion such that at least a portion of the magnet is positioned at a center point of the bottom portion,
wherein no part of the opening is positioned over the center point of the bottom portion,
wherein the opener body is configured to engage and remove the bottle cap from the bottle, and
wherein the magnet is configured to magnetically secure the removed bottle cap to the base device.

2. The multifunctional base device according to claim 1, wherein the opening and the opener body each form an oval shape.

3. The multifunctional base device according to claim 1, wherein the magnet has at least a 10-lb pull force.

4. The multifunctional base device according to claim 1, wherein the base device further comprises a shock absorber.

5. The multifunctional base device according to claim 1, wherein the base body further comprises a peripheral wall extending from an outer edge of the bottom portion.

6. The multifunctional base device according to claim 5, wherein the peripheral wall comprises threads.

7. A multifunctional beverage device comprising:
a base device for opening a bottle cap from a bottle, the base device comprising:
a base body comprising a bottom portion through which an opening is formed, and a peripheral wall extending from an outer edge of the bottom portion;
an opener body that is fixed to an upper surface of the bottom portion around the opening; and
a magnet that is fixed to the upper surface of the bottom portion such that at least a portion of the magnet is positioned over a center point of the bottom surface,
wherein no part of the opening is positioned at the center point of the bottom portion,
wherein the opener body is configured to engage and remove the bottle cap from the bottle, and
wherein the magnet is configured to magnetically secure the removed bottle cap to the base device; and
a beverage container holding body configured to receive a beverage container and that is attached to the peripheral wall of the base device.

8. The multifunction beverage device according to claim 7, wherein the opening and the opener body each form an oval shape.

9. The multifunction beverage device according to claim 7, wherein the magnet has at least a 10-lb pull force.

10. The multifunction beverage device according to claim 7, wherein the base device further comprises a shock absorber.

11. The multifunction beverage device according to claim 7, wherein the beverage container holding body is attached to the peripheral wall of the base device through pressing or welding.

12. The multifunction beverage device according to claim 7, wherein:
the peripheral wall comprises first threads;
the beverage container body comprises second threads; and
the beverage container holding body is attached to the peripheral wall of the base device through engagement of the first threads and the second threads.

13. A method of using a multifunctional beverage device comprising: a base device for opening a bottle cap from a bottle, the base device comprising: a base body comprising a bottom portion through which an opening is formed, and a peripheral wall extending from an outer edge of the bottom portion; an opener body that is fixed to an upper surface of the bottom portion around the opening; and a magnet that is fixed to the upper surface of the bottom portion such that at least a portion of the magnet is positioned over a center point of the bottom surface, wherein no part of the opening is positioned at the center point of the bottom portion, wherein the opener body is configured to engage and remove the bottle cap from the bottle, and wherein the magnet is configured to magnetically secure the removed bottle cap to the base device; and a beverage container holding body configured to receive a beverage container and that is attached to the peripheral wall of the base device, the method comprising:
inserting the bottle cap in the opening such that an edge of the bottle cap rests on the opener body;
exerting a force on at least one of the multifunctional beverage device and the bottle such that the bottle cap is removed from the bottle; and
detaching the removed bottle cap from the multifunctional beverage device.

14. The method according to claim 13, wherein the method further comprises inserting the bottle in the beverage container holding body.

15. The method according to claim 13, wherein the method further comprises placing the multifunctional beverage device on a metallic surface such that the multifunctional beverage device is magnetically secured to the metallic surface.

16. The method according to claim 15, wherein the metallic surface is inclined.
